(19) United States
(12) Patent Application Publication
(10) Pub. No.: US 2006/0269179 A1
(43) Pub. Date: Nov. 30, 2006

(54) Oil-impregnated sintered bearing

(76) Inventors: Motohiro Miyasaka, Matsudo-shi (JP); Hiroyuki Yoshida, Kiryu-shi (JP); Michio Okada, Kiryu-shi (JP); Tooru Tsukuda, Kiryu-shi (JP); Mitsunari Ishizaki, Kiryu-shi (JP); Norihito Mizote, Kiryu-shi (JP); Hidetaka Sando, Kiryu-shi (JP)

Correspondence Address: OLIFF & BERRIDGE, PLC, P.O. BOX 19928, ALEXANDRIA, VA, 22320, US

(21) Appl. No.: 10/561,221

(22) PCT Filed: Jun. 9, 2004
(86) PCT No.: PCT/JP04/08043

§ 371 Date: Dec. 19, 2005

(30) Foreign Application Priority Data
Jun. 20, 2003 (JP) 2003-176114

(51) Int. Cl. F16C 33/02

(52) U.S. Cl. 384/279

(57) ABSTRACT

An object of the present invention is to provide an oil-impregnated sintered sliding bearing which has a large amount of the lubricating oil as a bearing element which has long life, has a small amount of scattered and lost lubricating oil, has a simple structure, and takes up a small space for a bearing. An oil-impregnated sintered sliding bearing includes: an axis; plural porous sintered compacts joined with each other by sizing; a cavity between the sintered compacts at an axial direction center portion; and a gap which continuously extends from an end portion of the cavity and has a width narrower than the cavity, wherein the gap opens to an end surface or a peripheral surface of the bearing.

### TECHNICAL FIELD

The present invention relates to an oil-impregnated sintered sliding bearing, and in particular relates to an oil-impregnated sintered sliding bearing which has a superior lifetime and has a simple structure thereof.

### BACKGROUND ART

An oil-impregnated sintered sliding bearing is composed of a porous sintered alloy having pores in which lubricating oil is contained. The oil-impregnated sintered sliding bearing has an open porosity of about 15 to 30%. It is known that friction increases and seizure occurs in cases in which about 50% of the lubricating oil in the pores is lost. In order to prevent the friction increase, means for increasing the amount of the lubricating oil which is a bearing element are as follows. (1) A felt containing lubricating oil is provided outside an oil-impregnated sintered sliding bearing (see Patent Document 1). (2) In producing an oil-impregnated sintered sliding bearing, a core of a material such as a wax or a resin is embedded in a metal powder filled in a die, compacted and sintered with metal powder, and lubricating oil is contained in a cavity that is formed by the core being vaporized or burned by sintering (see Patent Document 2).

Means for preventing leakage of lubricating oil are known as follows. (3) A sintered metal member for absorbing lubricating oil is provided so as to contact an end surface of an oil-impregnated sintered sliding bearing, wherein the sintered metal member is more porous than the oil-impregnated sintered sliding bearing (see Patent Document 3). (4) Recesses are provided concentrically or in all directions on a bearing end surface, and lubricating oil is held in the recesses by surface tension of the lubricating oil (see Patent Document 4).

Patent Document 1 is Japanese Examined Utility Model Application Publication No. S55-23064. Patent Document 2 is Japanese Examined Patent Application Publication No. S28-4456. Patent Document 3 is Japanese Examined Utility Model Application Publication No. H8-9450. Patent Document 4 is Japanese Examined Utility Model Application Publication No. S53-53787.

### DISCLOSURE OF THE INVENTION

### Problems Solved by the Invention

However, in general, in the technique using the felt as a supplying oil means except for the pores of the bearing, the felt is disposed on an outside diameter side of the bearing, and lubricating oil is supplied from an outside diameter surface of the bearing, but it is difficult to ensure reliable adhesion between the felt and the bearing, and oil leakage possibly occurs from the felt. In the technique using the wax or the resin to have the cavity for containing lubricating oil in the bearing, the lubricating oil in the cavity thermally expands when the temperature of the bearing rises during the action of the bearing. A large amount of the lubricating oil, which is more than necessary, flows from an inside peripheral surface and an end surface of the bearing. The lubricating oil is scattered by a rotation of a shaft, and is lost. That is, in the cavity having a capillary attraction lower than on the periphery thereof, the lubricating oil is merely lost and is replaced by the air. When the shaft is rotated again in this condition, since thermal expansion of the air in the cavity is relatively large, the lubricating oil in the oil-impregnated sintered sliding bearing is discharged outside and is lost. As a result, expected effects by securing the lubricating oil in the cavity cannot be obtained. In the technique in which the porous sintered member or the felt for absorbing the lubricating oil is provided in an edge surface of the oil-impregnated sintered sliding bearing as a means for securing the lubricating oil in the bearing element, since the porous sintered member, etc., are provided outside the bearing, the bearing element having the bearing housing is large. In the technique using the recesses formed concentrically or in all directions on the bearing end surface, effects by preventing leakage of lubricating oil are small in cases in which the recesses are not deep. In particular, in compact bearings, it is difficult to form the recesses, so that effects by preventing leakage of lubricating oil cannot be obtained sufficiently.

As described above, the conventional techniques do not have the all characteristics that the amount of the lubricating oil as the bearing element is large for a long lifetime of the bearing, a small amount of the lubricating oil is scattered and is lost, and the structure thereof is simple and compact. In recent years, the development of a production technique for the oil-impregnated sintered sliding bearing having all these characteristics is required.

The present invention was made in consideration of the above requirements. An object of the present invention is to provide an oil-impregnated sintered sliding bearing which can have a large amount of the lubricating oil as the bearing element so as to have long lifetime. An object of the present invention is to provide an oil-impregnated sintered sliding bearing in which the amount of scattered and lost lubricating oil is small. An object of the present invention is to provide an oil-impregnated sintered sliding bearing which can have a simple structure and thereby reduce the space taken up thereby.

### Means for Solving the Problems

According to one aspect of the present invention, as described in claim 1, an oil-impregnated sintered sliding bearing includes: an axis; plural porous sintered compacts joined with each other by sizing; a cavity provided between the sintered compacts at a center portion of the bearing in a direction of the axis; and a gap extending continuously from an end portion of the cavity along the axis or in a radial direction and having a width narrower than that of the cavity. The gap has an opening at an end surface of the bearing or at a peripheral surface of the bearing.

In this case, the above gap preferably has the following shape. That is, as described in claim 2, the gap may be at least one recess stripe provided between an outside member of the sintered compacts and an inside member of the sintered compacts, or the gap may be composed of recess stripes which are provided between the outside member and the inside member and are gear-shaped in a plan view.

According to a preferred embodiment of the present invention, the bearing may have a housing, and the bearing and the housing may have the following structures. That is, as described in claim 3, the bearing may have a spherical surface or a chamfer portion at an edge of the peripheral surface on a side of the opening of the gap, and an angle between the spherical surface or the chamfer portion and the inside surface of the housing may be 45 degrees or less. Alternatively, as described in claim 4, the bearing may have an outside diameter which is smaller than an inside diameter of the housing, or the bearing may have plural recess stripes provided to an peripheral portion of the bearing so as to extend along the axis, so that another gap is formed between the peripheral surface of the bearing and the inside surface of the housing proximate to the opening of the gap.

According to a preferred embodiment of the oil-impregnated sintered sliding bearing of the present invention, as described in claim 5, an inside member of the sintered compacts may project along the axis with respect to an outside member of the sintered compacts on a side of the opening of the gap, so that the bearing has a step formed on the side thereof. Alternatively, as described in claim 6, an inside member of the sintered compacts may have a flange portion at an end portion thereof on a side of the opening of the gap, and a ring-shaped gap may be formed among an end surface of the outside member of the sintered compacts, a lower surface of the flange portion of the inside member, and the inside surface of the housing. Alternatively, as described in claim 7, the flange portion of the inside member may have an outside diameter smaller than an inside diameter of the housing, or plural recess stripes may be provided on a peripheral portion of the flange portion so as to extend along the axis, so that another gap is formed between a peripheral surface of the flange portion and the inside surface of the housing.

According to a preferred embodiment of the present invention, the bearing may have the following structure on an inside peripheral portion. That is, as described in claim 8, the bearing may have a chamfer portion at an inside peripheral edge at least on a side of the opening of the gap, and may have a tapered shape at an inside peripheral edge of an end portion thereof, so that clearance between an inside peripheral surface of the bearing and a shaft inserted into the bearing at an end portion of a sliding surface is larger than that at a center portion thereof. As described in claim 9, the bearing may have an inside diameter at least at the other end portion opposite to a side of the opening of the gap, the inside diameter being larger than those at portions other than the other end portion, so that clearance between an inside peripheral surface of the bearing and a shaft inserted into the bearing at an end portion of a sliding surface is larger than that at a center portion thereof. As described in claim 10, the large inside diameter portion of the other end portion is formed by the outside member of the sintered compacts.

According to a preferred embodiment of the oil-impregnated sintered sliding bearing of the present invention, as described in claim 11, an inside member of the sintered compacts may have an open porosity or an average pore diameter, which is smaller than that of the outside member.

### EFFECTS OF THE INVENTION

In the oil-impregnated sintered sliding bearing of the present invention, lubricating oil is impregnated in the pores of the sintered bearing, the cavity, and the gap. The sintered bearing is mounted to the housing and is used. In initial running in the use, when the lubricating oil is discharged to the surface thereof by temperature rise thereof due to the rotation of the shaft, the lubricating oil is easily discharged outside the bearing via the gap. The lubricating oil is discharged to the end surface portion on a side of the opening of the gap, and is held by surface tension of the lubricating oil in a corner space portion between the housing and the end surface of the bearing, a corner space portion between the housing and the chamfer portion at the peripheral edge of the bearing, or a corner space portion between the spherical surface at the periphery of the bearing and the housing. In a case in which angle at the corner space portion is smaller, the lubricating oil is more sufficiently held. In particular, the angle is preferably 45 degrees or less in order to sufficiently hold the lubricating oil in the corner space portion due to the wettability of the lubricating oil. Although the minimum of the angle is not especially determined, the angle is preferably 25 degrees or more in order to hold sufficient amount of the lubricating oil in the depth of the corner space portion.

Since the lubricating oil held in the corner space portion contacts the peripheral surface of the sintered bearing, the lubricating oil is absorbed from the pores of the sintered bearing by contraction of the lubricating oil in the sintered bearing due to temperature fall in stop of running or by capillary attraction working between the insides of the pores and the lubricating oil in order to solve a shortage of the lubricating oil in the sintered bearing. In this manner, the lubricating oil held in the corner space portion contributes to supplying of the lubricating oil in the sintered bearing. Although the cavity and the gap has a function for holding the lubricating oil at corner portions on which surface tension of the lubricating oil works, a large part of the lubricating oil is replaced by the air, so that the cavity and the gap lose the ability to hold the lubricating oil. In a cylindrical bearing, the opening of the gap is in the end surface of the bearing since the periphery of the bearing is press-fitted in the housing. In a case in which in an aligning bearing, the spherical portion on the periphery of the bearing is opened from the housing, or lubricating oil can be held on an inside wall surface of the housing, the opening can be in the spherical surface.

In the above manner, the cavity can be used for a oil reservoir only in initial running in which the bearing is used, and the gap communicating from the cavity to the surface is used for a guide passage through which lubricating oil discharged from the bearing is supplied to a predetermined place more than other places. As a result, the lubricating oil discharged from the bearing exists by surface tension of the lubricating oil proximately to a corner portion formed by the inside surface of the housing and the end surface of the bearing without using an oil absorber, for example, a felt. Therefore, scattering and loss of the lubricating oil can be inhibited. Even if a felt is provide to the corner portion, scattering and loss of the lubricating oil can be inhibited, so that a felt can be provided thereto. In this case, scattering and loss of the lubricating oil can be more inhibited.

In the one aspect of the present invention, in addition to ensuring sufficient amount of the lubricating oil and inhibiting scattering and loss of the lubricating oil as described above, the oil-impregnated sintered sliding bearing is formed by combining the plural porous sintered compacts by sizing, so that the structure of the bearing can be simple, and can thereby reduce space taken up thereby.

### BEST MODE FOR CARRYING OUT THE INVENTION

Embodiments will be explained hereinafter with reference to drawings. FIG. 1 is a schematic longitudinal-sectional view showing structures of bearing elements in conditions in which an assembled oil-impregnated sintered sliding bearing of the present invention is used. FIG. 2 is a longitudinal-sectional view of each member which is a component of the bearing. A bearing 1 is produced as described below. An inside member 3 is fit into an outside member 2, the members 2 and 3 are integrally joined with each other by sizing in a die, or are mounted to a housing 4, and the members 2 to 4 are subjected to sizing in a die.

The outside member 2 has a large diameter portion 2a and a small diameter portion 2b. The small diameter portion 2b is connected with the large diameter portion 2a, and has a diameter smaller than that of the large diameter portion 2a. The small diameter portion 2b has plural recess stripes 2c which are formed on an inside periphery thereof, thereby being gear-shaped in a plan view (viewed from the left side in FIG. 2). The outside member 2 has chamfer portions 2d which are formed at peripheral edge portions thereof. The inside member 3 has a small diameter portion 3a and a large diameter portion 3b. The large diameter portion 3b is connected with the small diameter portion 3a, and has a diameter larger than that of the small diameter portion 3a. The large diameter portion 3b has plural recess stripes 3c which are formed on a periphery thereof. The outside member 2 and the inside member 3 are sintered compacts. The members 2 and 3 are integrally joined with each other by compressing them in a die, a gap 5 is formed by the recess stripes 2b and 3b, and a cavity 6 is formed due to difference in length between step portions of the members 2 and 3. The bearing 1 produced in the above manner is subjected to oil-impregnation process. The bearing 1 is mounted to the housing 4, and a shaft 7 is inserted into the bearing 1. Pores, the cavity 6, and the gap 5 of the bearing 1 are subjected to oil-impregnation process beforehand. The amount of the lubricating oil contained in the cavity 6 of the bearing 1 corresponds 100% of the amount of open pores based on open pores of a typical porous sintered bearing.

In the case in which the shaft 7 is rotated, a sliding surface is lubricated by a lubricating mechanism specific to the oil-impregnated sintered sliding bearing, the temperature of the bearing 1 rises by the rotation of the shaft 7, so that the lubricating oil in the bearing 1 is exuded so as to flow to a bearing surface. In this case, in addition, the lubricating oil in the cavity 6 is discharged to an end surface of the bearing 1 via the gap 5 which is a thick passage. The discharged lubricating oil is accumulated at corner portions which are formed between the housing 4 and the bearing 1, so that oil reservoirs 8 are formed. Oil volumes of the oil reservoirs 8 are increased by forming the chamfer portions 2d. In a case in which an angle between the housing 4 and each chamfer portion 2d is set to 45 degrees or less, the lubricating oil can be sufficiently accumulated at the corner portions due to wettability of the lubricating oil. In a case in which an angle between the housing 4 and each chamfer portion 2d is set to 25 degrees or more, the sufficient amount of the lubricating oil can be accumulated at an innermost of each corner space portion.

When the rotation of the shaft 7 is stopped, the temperature of the bearing 1 is fallen, the pores of the bearing 1 absorbs the lubricating oil which exists at the bearing surface and the oil reservoirs 8. In order to increase the absorbance of the oil and the accumulation amount of the oil, it is preferable that the outside member 2 be a sintered compact having open porosity greater than that of the inside member 3. The outside member 2 is composed of a sintered material different from that of the inside member 3 having the bearing sliding surface. As a result, for example, the outside member 2 can be an inexpensive material in comparison with the inside member 3, so that production cost can be reduced. When the lubricating oil is absorbed in the bearing 1, capillary attraction can hardly be worked in the cavity 6 and the gap 5, so that the lubricating oil discharged once hardly returns to the cavity 6 and the gap 5, and is replaced by the air flowing from the gap 5, etc. In this manner, by performing initial running several times, the amount of the lubricating oil is appropriately balanced among the cavity 6, the gap 5, and the oil reservoirs 8.

In this manner, the cavity 6 and the gap 5 functions as oil reservoirs before the bearing elements are assembled, and the lubricating oil is accumulated in the oil accumulation portions 8 outside the bearing 1 by the rotation of the shaft 7. After the bearing elements are assembled, the amount of the lubricating oil in the bearing elements can be relatively large by this oil accumulation method without supplying the lubricating oil thereto, so that operation lifetime of the oil-impregnated sintered sliding bearing can be long.

FIG. 3 is a schematic longitudinal-sectional view showing bearing elements of an aligning bearing. FIG. 4 is a longitudinal-sectional view showing each member of a bearing 11 before sizing in production for the bearing 11 shown in FIG. 3. The bearing 11 can be formed as described below. Sintered compacts of a recess member 12 and a protrusion member 13 as shown in FIG. 4 are fit to each other, and are subjected to compression sizing in a typical spherical die, and each periphery thereof is formed so as to have a spherical surface. The recess member 12 has plural radial recess stripes 12a which are formed at an end surface portion thereof. The recess stripes 12a face the protrusion member 13, so that a gap 14 is thereby formed. A cavity 15 is a portion surrounded by an inside peripheral step portion of the recess member 12 and the protrusion member 13. In this example, the gap 14 opens to a peripheral spherical surface portion. By providing the recess stripe shown in FIG. 2, the gap 14 extending from the cavity 15 can be formed on a connecting surface parallel to an axis. The bearing 11 subjected to the sizing and the oil-impregnation process is mounted to the housing 16. A shaft 17 is inserted into the bearing 11. The action of the lubricating oil in the cavity 15 and the gap 14 by the operation of the bearing 11 is the same as that described above. The oil reservoirs 18 are formed at space portions of which longitudinal sections of the cavity 15 and the gap 14 are triangle-shaped and proximate to an end surface portion of the bearing 11.

FIG. 5 is a longitudinal-sectional view showing a spherical bearing 21 which is a modification example of the spherical bearing 11 shown in FIG. 3. In this example, a gap 23 communicating from a cavity 22 to the outside opens to an end surface side of the bearing 21, so that the example shown in FIG. 5 is structured such that discharge of the lubricating oil on the end surface side is preceded differently from the example shown in FIG. 3. The lubricating oil discharged in this manner flows through a groove 21a formed on a peripheral surface of the spherical bearing 21, and then is accumulated in a gap portion between the spherical bearing 21 and a housing 24. In a case in which the housing 24 has a structure shown in the Figure, the lubricating oil can be accumulated in the gap portion. A felt can be appropriately provided to the gap portion. In a case in which a shaft 25 is used, the lubricating oil in the gap portion is absorbed from an oil reservoir 26 to a outside member 27, and moves to an inside member 28 by a capillary attraction. Therefore, on the end surface portion and inside the bearing, a mechanism in which the lubricating oil is circulated is obtained, and long lifetime of the oil-impregnated sintered sliding bearing is obtained. Since an inside diameter of the outside member 27 is larger than that of the inside member 28, the other end surface can have a function in which leakage oil flowing through the shaft 25 is absorbed in the outside member 27. The lubricating oil moves to the inside member 28 by a capillary attraction in the same manner as the lubricating oil absorbed from the oil reservoir 26. In this manner, the oil circulating function can be obtained on the above other end surface.

FIGS. 6A to 6F are longitudinal-sectional schematic views showing combination features of protrusion members (inside members) 33a to 33f and recess members (outside members) 34a to 34f for forming cavities 31a to 31f and gaps 32a to 32f in cylindrical bearings. In the Figures, reference numerals 35a to 35c, 35e, and 35f show facing portions which are exposed on end surfaces between the members, reference numerals 36a to 36e are facing portions which are exposed on peripheries, and reference numerals 37d and 37f are facing portions exposed on inside peripheries.

An example shown in FIG. 6A is a combination feature of the cylindrical protrusion member 33a and the recess member 34a, wherein the cylindrical protrusion member 33a has a flange and the recess member 34a has a chamfer portion on an end surface on an inside peripheral side thereof. In this example, the cavity 31a is surrounded by a small diameter portion and a large diameter portion of the protrusion member 33a, and a chamfer portion of the recess member 34a, thereby being triangle-shaped in longitudinal section. The facing portions of the members 33a and 34a are the facing portion 35a exposed on the end surface, and the facing portion 36a exposed on the periphery. In each facing portion 35a and 36a, the gap 32a may be formed therein if necessary.

An example shown in FIG. 6B is a combination feature of the members 33b and 34b having substantially the same shapes as those of the example shown in FIG. 6A. The example shown in FIG. 6B differs from the example shown in FIG. 6A in that the end surface portion on the inside diameter side of the recess member 34b is step-shaped, and the cavity 31b is square-shaped in longitudinal section. The combination feature shown in FIGS. 6A and 6B does not have a complicated shape, and can be easily formed.

An example shown in FIG. 6C is a combination feature of the members 33c and 34c having shapes similar to those of the example shown in FIG. 6B. The example shown in FIG. 6C differs from the example shown in FIG. 6B in that the periphery side of the protrusion member 33c has three steps, and the protrusion member 33c and the recess member 34c are fit in each other at two portions and are joined thereat. In the example shown in FIG. 6C, since the protrusion member 33c has a complicated shape and a thin wall thickness portion in comparison with the example shown in FIG. 6B, it is difficult to use this example for a compact size bearing. However, since the members 33c and 34c are strongly connected, the example shown in FIG. 6C is desirably used for bearings having a gap which opens to one end surface thereof.

An example shown in FIG. 6D is a combination feature in which the members 33d and 34d having shapes similar to those of the example shown in FIG. 6B. The example shown in FIG. 6D differs from the example shown in FIG. 6B in that a sliding surface 37d comprises a portion of the recess member 34d. In the example shown in FIG. 6D, portions at which the gap 32d opens to a surface are the periphery 36d and the inside periphery 37d of the recess member 33d. In the cylindrical bearing shown in FIG. 6D, for example, a recess groove (not shown) is required for forming an oil reservoir in a housing.

An example shown in FIG. 6E is a combination feature of the two outside members 34e having simple cylindrical shapes and the inside member 33e having a simple cylindrical shape. The cavity 31e is formed by a chamfer portion which is on an inside diameter side of the outside member 34e. The example shown in FIG. 6E has more members than the examples shown in FIGS. 6A to 6D, but is easily produced regardless of the size of the bearing, since the shapes of the members are simple. The gap 32e can open to a periphery and an end surface of the bearing, and can be selected in accordance with a purpose of using the bearing.

An example shown in FIG. 6F is a combination feature of the members 33f and 34f having the shapes similar to those of the example shown in FIG. 6D. The example shown in FIG. 6F differs from the example shown in FIG. 6D in that the gap 32f opens to the end surface 35f and the inside periphery 37f of the protrusion portion 33f and the recess member 34f. In the example shown in FIG. 6F, for example, a recess groove (not shown in the Figure) is required for forming an oil reservoir in a housing. It should be noted that in the respective features shown in FIGS. 6A to 6F, the respective members are repressed compacts (which are subjected to sizing).

The bearings described above are basic types of the bearings of the present invention, and desirable embodiments of the present invention will be explained in detail, in which the above patterns are further combined.

FIG. 7 is a longitudinal-sectional view showing another desirable example of a cylindrical bearing. The bearing of this example has an inside member 41 having a protruded shape and an outside member 42 having a recessed shape, the members 41 and 42 being joined with each other by sizing. In this example, a cavity 43, gaps 44 and 45, a step 46, a large inside diameter portion 47, and a chamfer portion 48 are formed in the same manner as described above. By these respective members, lubricating oil can be discharged outside the bearing, can be accumulated in the bearing elements, and can be supplied from the oil reservoir to the oil-impregnated sintered bearing.

FIG. 8 is a longitudinal-sectional view showing another desirable example of a cylindrical bearing. The bearing of this example has an inside member 51 having a protruded shape and an outside member 52 having a recessed shape, the members 51 and 52 being joined with each other by sizing. In this example, a cavity 53, the gaps 54 to 56, chamfering portions 57 and 58, and a flange portion 59 are formed in the same manner as described above. In this example, by these respective members, lubricating oil can be discharged outside the bearing, can be accumulated in the bearing members, and can be supplied from the oil reservoir to the oil-impregnated sintered bearing.

FIG. 9 is a longitudinal-sectional view showing another desirable example of an aligning bearing. The bearing of this example has an inside member 61 having a protruded shape and outside member 62 having a recessed shape, the members 61 and 62 being joined with each other by sizing. In this example, a cavity 63, gaps 64 to 66, and a chamfer portion 67 are formed in the same manner as described above. In this example, by these respective members, lubricating oil can be discharged outside the bearing, can be accumulated in the bearing elements, and can be supplied from the oil reservoir to the oil-impregnated sintered bearing.

FIG. 10 is a longitudinal-sectional view showing another desirable example of an aligning bearing. The bearing of this example has an inside member 71 having a protruded shape and an outside member 72 having a recessed shape, and these members 71 and 72 being joined with each other by sizing. In this example, a cavity 73, a gap 74, a step 75, a large diameter portion 76, and a chamfer portion 77 are formed in the same manner as described above. In this example, by these respective members, lubricating oil can be discharged outside the bearing, can be accumulated in the bearing elements, and can be supplied from the oil reservoir to the oil-impregnated sintered sliding bearing.

### INDUSTRIAL APPLICABILITY

As explained above, in the oil-impregnated sintered sliding bearing of the present invention having a simple structure, when the bearing is used, lubricating oil can be discharged outside the bearing via the passage, can be accumulated in the bearing elements, and can be supplied from the oil reservoir to the bearing. Therefore, the amount of the lubricating oil can be sufficiently secured without supplying lubricating oil when the bearing is assembled. As a result, long operating lifetime of the bearing can be obtained. Therefore, the present invention is promising in that the present invention can be applied to oil-impregnated sintered sliding bearings which are desirably used for various sintered mechanical parts.

### BRIEF DESCRIPTION OF DRAWINGS

FIG. 1 is a longitudinal-sectional view of bearing elements using cylindrical bearing according to the present invention.

FIG. 2 is a longitudinal-sectional view of each member of the bearing shown in FIG. 1.

FIG. 3 is a longitudinal-sectional view of bearing elements using an aligning bearing according to the present invention.

FIG. 4 is a longitudinal-sectional view of each member of the bearing shown in FIG. 3.

FIG. 5 is a longitudinal-sectional view of another of the bearing elements using an aligning bearing according to the present invention.

FIGS. 6A to 6F are longitudinal-sectional schematic views showing various combination features of members of a cylindrical bearing in a case in which the bearing is used.

FIG. 7 is a longitudinal-sectional view showing a desirable example of a cylindrical bearing.

FIG. 8 is another longitudinal-sectional view showing another desirable example of a cylindrical bearing.

FIG. 9 is a longitudinal-sectional view showing another desirable example of an aligning bearing.

FIG. 10 is a longitudinal-sectional view showing another desirable example of an aligning bearing.

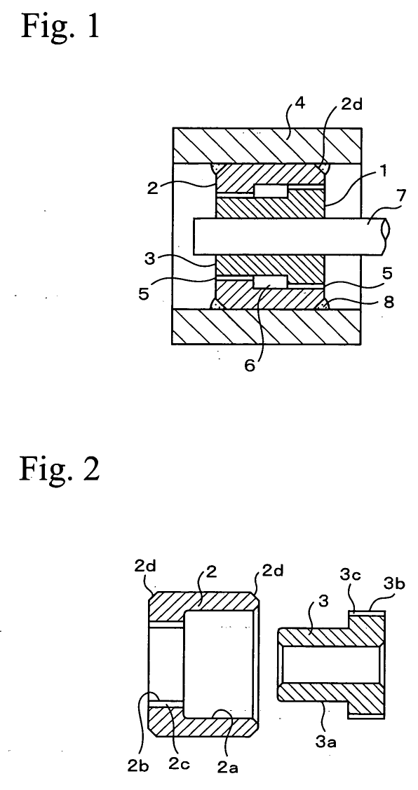

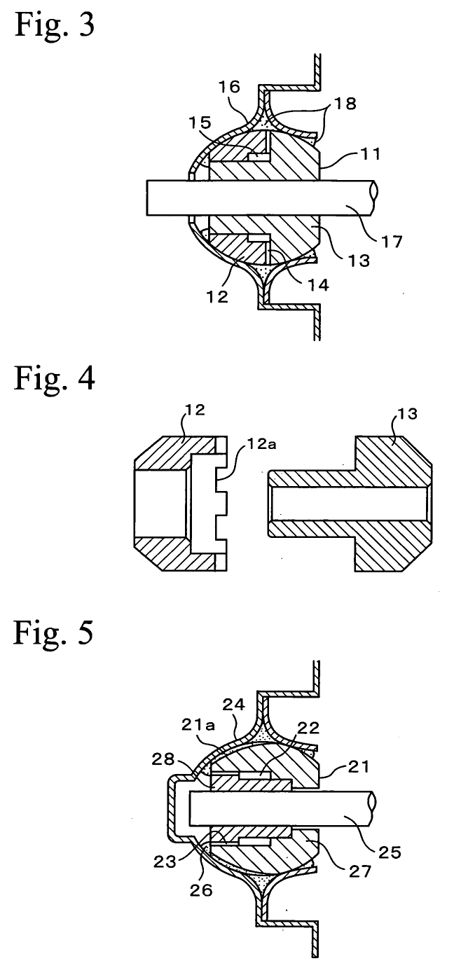

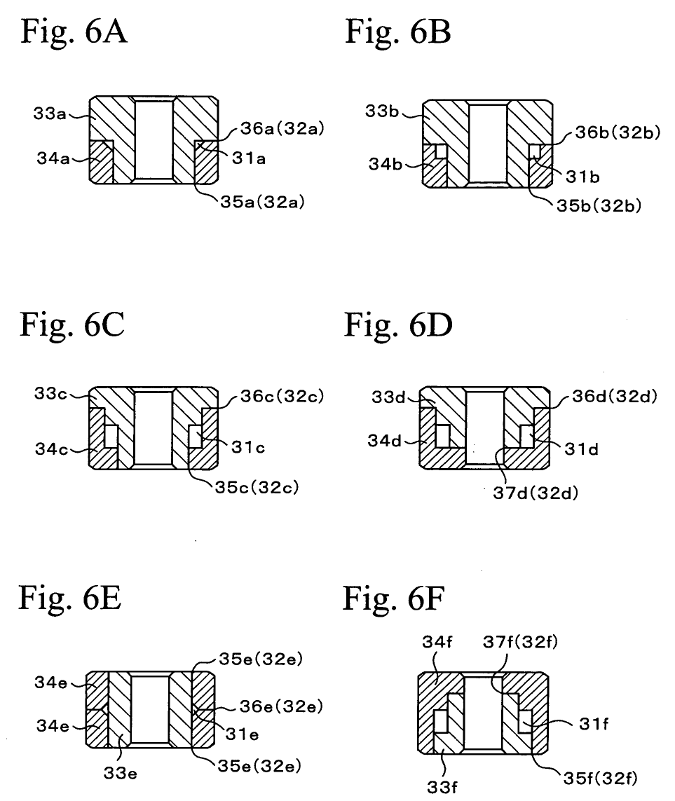

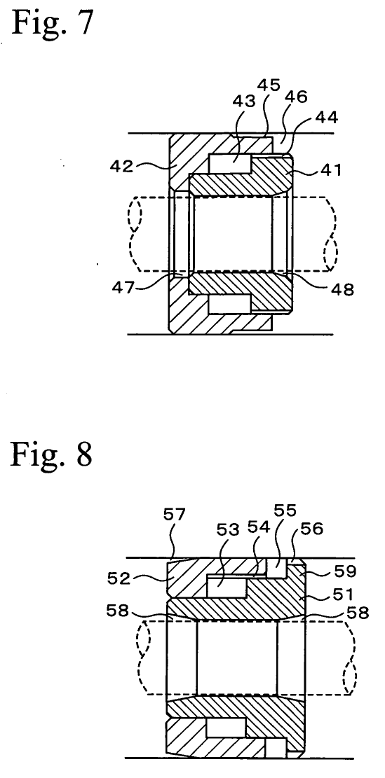

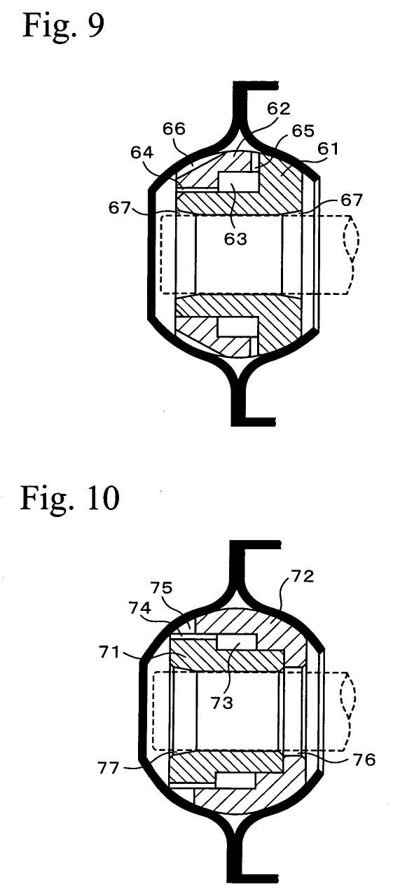

### EXPLANATION OF REFERENCE NUMERALS

1 bearing,
2 outside member,
2d chamfer portion,
3 inside member,
4 housing,
5 gap,
6 cavity,
7 shaft,
8 oil reservoir

1. An oil-impregnated sintered sliding bearing comprising:
an axis;
plural porous sintered compacts joined with each other by sizing;
a cavity provided between the sintered compacts at a center portion of the bearing in a direction of the axis; and
a gap continuously extending from an end portion of the cavity along the axis or in a radial direction and having a width narrower than that of the cavity,
wherein the gap has an opening at an end surface of the bearing or a peripheral surface of the bearing.

2. The oil-impregnated sintered sliding bearing according to claim 1,
wherein the gap is at least one recess stripe provided between an outside member of the sintered compacts and an inside member of the sintered compacts, or the gap is composed of recess stripes which are provided between the outside member and the inside member and are gear-shaped in a plan view.

3. The oil-impregnated sintered sliding bearing according to claim 1,
wherein the bearing further comprises a housing having an inside surface, and the bearing has a spherical surface or a chamfer portion at an edge of the peripheral surface on a side of the opening of the gap, and an angle between the spherical surface or the chamfer portion and the inside surface of the housing is 45 degrees or less.

4. The oil-impregnated sintered sliding bearing according to claim 1, wherein the bearing further comprises a housing having an inside surface, and the bearing has an outside diameter which is smaller than an inside diameter of the housing, or the bearing has plural recess stripes provided to an peripheral portion of the bearing so as to extend along the axis, so that another gap is formed between the peripheral surface of the bearing and the inside surface of the housing proximate to the opening of the gap.

5. The oil-impregnated sintered sliding bearing according to claim 1, wherein an inside member of the sintered compacts projects along the axis with respect to an outside member of the sintered compacts on a side of the opening of the gap, so that the bearing has a step formed on the side of the opening.

6. The oil-impregnated sintered sliding bearing according to one claim 1, wherein the bearing further comprises a housing having an inside surface, an inside member of the sintered compacts has a flange portion at an end portion thereof on a side of the opening of the gap, and a ring-shaped gap is formed among an end surface of the outside member of the sintered compacts, a lower surface of the flange portion of the inside member, and the inside surface of the housing.

7. The oil-impregnated sintered sliding bearing according to claim 6, wherein the flange portion of the inside member has an outside diameter smaller than an inside diameter of the housing or plural recess stripes are provided on a peripheral portion of the flange portion so as to extend along the axis, so that another gap is formed between a peripheral surface of the flange portion and the inside surface of the housing.

8. The oil-impregnated sintered sliding bearing according to claim 1, wherein the bearing has a chamfer portion at an inside peripheral edge at least on a side of the opening of the gap, and has a tapered shape at an inside peripheral edge of an end portion thereof, so that clearance between an inside peripheral surface of the bearing and a shaft inserted into the bearing at an end portion of a sliding surface is larger than that at a center portion thereof.

9. The oil-impregnated sintered sliding bearing according to claim 1, wherein the bearing has an inside diameter at least at the other end portion opposite to a side of the opening of the gap, the inside diameter being larger than those at portions other than the other end portion, so that clearance between an inside peripheral surface of the bearing and a shaft inserted into the bearing at an end portion of a sliding surface is larger than that at a center portion thereof.

10. The oil-impregnated sintered sliding bearing according to claim 9, wherein the large inside diameter portion of the other end portion is formed by the outside member of the sintered compacts.

11. The oil-impregnated sintered sliding bearing according to claim 1, wherein an inside member of the sintered compacts has an open porosity or an average pore diameter, which is smaller than that of the outside member.
